(19) United States
(12) Patent Application Publication
(10) Pub. No.: US 2024/0019998 A1
(43) Pub. Date: Jan. 18, 2024

(54) METHOD AND DEVICE FOR IMPLEMENTING USER INTERFACE OF LIVE AUCTION

(71) Applicant: RXC INC., Seoul (KR)

(72) Inventors: Jisu HA, Hanam-si (KR); Changhyun LEE, Seoul (KR)

(73) Assignee: RXC INC., Seoul (KR)

(21) Appl. No.: 18/358,256

(22) Filed: Jul. 25, 2023

Related U.S. Application Data
(63) Continuation of application No. PCT/KR2023/003429, filed on Mar. 14, 2023.

(30) Foreign Application Priority Data
Mar. 15, 2022 (KR) 10-2022-0031934

(51) Int. Cl. G06F 3/0488; G06Q 30/08; G06F 3/04847

(52) U.S. Cl. CPC G06F 3/0488; G06Q 30/08; G06F 3/04847

(57) ABSTRACT

The present disclosure relates to a device and a method for implementing a user interface for live auction, and includes a screen display step of displaying a live auction screen on a display, a touch step of detecting a contact on the touch-sensitive surface at a certain position on the display, and a bid step of performing a first function when the contact with the touch-sensitive surface is released at the certain position after the contact is detected and performing a second function when the contact with the touch-sensitive surface at the certain position is maintained for a certain time or more, wherein the first function indicates a bid at a first price, and the second function indicates a change from the first price to a second price.

### CROSS-REFERENCE TO RELATED APPLICATION

This application is a continuation of International Application No. PCT/KR2023/003429 designating the United States, filed on Mar. 14, 2023, in the Korean Intellectual Property Receiving Office and claiming priority to Korean Patent Application No. 10-2022-0031934 filed on Mar. 15, 2022, in the Korean Intellectual Property Office, the disclosures of which are incorporated by reference herein in their entireties.

### BACKGROUND

### 1. Field

The present disclosure relates to a device and a method for implementing a user interface for live auction.

### 2. Description of the Related Art

Recently, the live commerce market that uses mobile devices has grown rapidly not only in Korea but also abroad. According to Kyobo Securities Research Center and Korea Internet & Security Agency (KISA), the domestic live commerce market is expected to grow to 10 trillion won in 2023, and the e-commerce penetration rate is expected to reach 4%. The country where live commerce is most active globally is China, and since live commerce started in 2017 in China, the live commerce has grown rapidly for about 5 years, and as a result, it is expected that the scale of live commerce reaches 2.8 trillion yuan in 2022 and an e-commerce penetration rate reaches 20%.

TMON, which is a Korean company, started live commerce in 2017 for the first time among domestic distributors and has been conducting live broadcasts over 3,000 times so far, and since a service of Grip that is a live C2C platform is launched in February 2019, 17,000 celebrities entered a store and recorded cumulative sales of KRW 100 billion for 3 years so far, and the Grip was recently acquired by Kakao at a corporate value of KRW 400 billion. The domestic live commerce market is currently exclusively occupied by Naver Shopping Live, and live commerce services, such as Kakao Shopping Live, OK Cashback Oh! Labang, Jam Live, CJ OnStyle, SSG LIVE, and Baemin Shopping Live occupy the market. In addition, YouTube has announced to provide a live shopping function in Korea in 2022.
(Patent Document 1) Korean Registered Patent No. 10-2345522, E-COMMERCE SYSTEM AND METHOD FOR DETERMINING WINNERS THROUGH GAMES FOR LIVE COMMERCE, Grip Company, Inc.
(Patent Document 2) Korean Registered Patent No. 10-2212407, E-COMMERCE AND E-AUCTION SYSTEM USING LIVE STREAMING SERVICE FOR LIVE-COMMERCE, Finshot Inc.

### SUMMARY

However, the conventional live commerce has a problem in that an interface for live auction is not proposed separately.

Accordingly, an object of the present disclosure is to provide a device and a method for implementing a user interface for live auction that provides the user interface capable of performing a live auction in an interface environment in which images are streamed and displayed in real time.

Hereinafter, detailed means for achieving an object of the present disclosure will be described.

According to an aspect of the present disclosure, a user interface implementation method for live auction by an electronic device having a touch-sensitive surface and a display includes a screen display step of displaying a live auction screen on a display, a touch step of detecting a contact on the touch-sensitive surface at a certain position on the display, and a bid step of performing a first function when the contact with the touch-sensitive surface is released at the certain position after the contact is detected and performing a second function when the contact with the touch-sensitive surface at the certain position is maintained for a certain time or more, wherein the first function indicates a bid at a first price, and the second function indicates a change from the first price to a second price.

According to another aspect of the present disclosure, a user interface implementation method for live auction by an electronic device having a touch-sensitive surface and a display includes a screen display step of displaying a live auction screen on the display, a touch step of detecting a first input, which is a contact on the touch-sensitive surface, at a first position on the display, and a swipe step of detecting a second input that is a gesture including a continuous movement of the contact in a direction from the first position to a second position on the display, or detecting a third input that is a gesture including the continuous movement of the contact in a direction from the first position to a third position on the display without release of the contact with the touch-sensitive surface after the first input is detected, wherein the first function indicates a bid at a first price, and the second function indicates a change from the first price to a second price higher than the first price.

In addition, a start portion of a slider, which is a user interface element in a form of the slider in a certain direction, may be displayed at the first position on the display in the touch step, and an end portion of the slider may be displayed at the second position in the swipe step.

In addition, the second price may indicate a price relatively close to a successful bid than the first price.

In addition, in the bid step, when the first function is performed, a bid message, which is a user interface element in a form of a message for the bid at the first price, may be displayed on a certain position of the display.

According to another aspect of the present disclosure, a user interface implementation method for live auction by an electronic device having a touch-sensitive surface and a display includes a screen display step of displaying a live auction screen on the display, a touch step of detecting a first input, which is a contact on the touch-sensitive surface, at a first position on the display, and a swipe step of detecting a second input that is a gesture including a continuous movement of the contact in a direction from the first position to a second position on the display or detecting a third input that is a gesture including the continuous movement of the contact in a direction from the first position to a third position on the display, without release of the contact with the touch-sensitive surface after the first input is detected, wherein a first function is performed when the contact with the touch-sensitive surface is released at the first position after the first input is detected, a second function is performed when the second input is detected, and a third function is performed when the third input is detected, and the first function indicates a bid at a first price, the second function indicates a change from the first price to a second price higher than the first price, and the third function indicates a change from the first price to a third price lower than the first price.

According to another aspect of the present disclosure, a non-transitory computer-readable storage medium storing a program that is executed by a processor of an electronic device having a touch-sensitive surface and a display, wherein the program includes instructions for performing, on a computer, the user interface implementation method for live auction, according to an embodiment of the present disclosure.

According to another aspect of the present disclosure, an electronic device includes a touch-sensitive surface and a display, a processor, and a memory storing a program configured to be executed by the processor, wherein the program includes instructions for performing the user interface implementation method for live auction, according to an embodiment of the present disclosure.

In addition, the memory further may store a program code of a bid price determination reinforcement learning module, the processor may process the program code of the bid price determination reinforcement learning module, the program code of the bid price determination reinforcement learning module may configure an environment as a current price (a floor), a first price, participant information, bid information so far, and auction product information, configure a state as the first price, configure a state as the first price, a number of participants, and a bid rate, configure an action as determination of the second price, and configure reward as successful-bid possibility information, and the participant information may mean a number of participants to which a number of existing bids divided by a number of live auction participations of each participant are applied as weight values.

### BRIEF DESCRIPTION OF THE DRAWINGS

The accompanying drawings exemplify preferred embodiments of the present disclosure and serve to further understand the technical idea of the present disclosure together with the detailed description of the present disclosure, and the present disclosure should not be construed as being limited to only the matters described in the drawings.

FIG. 1 is a schematic view illustrating a live auction service device according to one embodiment of the present disclosure.

FIG. 2 is a configuration diagram of a mobile terminal device including a participant client that performs a user interface implementation operation for live auction according to one embodiment of the present disclosure.

FIG. 3 is a flowchart illustrating a user interface implementation method for participating in a live auction, according to one embodiment of the present disclosure.

FIG. 4 is a schematic view illustrating a screen display step according to the embodiment of the present disclosure.

FIG. 5 is a schematic view illustrating a touch step according to the embodiment of the present disclosure.

FIG. 6 is a schematic view illustrating a bid step according to the embodiment of the present disclosure.

FIG. 7 is a schematic view illustrating another bid step according to the embodiment of the present disclosure.

FIG. 8 is a flowchart illustrating a user interface implementation method for participating in a live auction according to a first modification example of the present disclosure.

FIG. 9 is a schematic view illustrating a screen display step according to the first modification example of the present disclosure.

FIG. 10 is a schematic view illustrating a touch step according to the first modification example of the present disclosure.

FIG. 11 is a schematic view illustrating a swipe step according to the first modification example of the present disclosure.

FIG. 12 is a schematic view illustrating a bid step according to the first modification example of the present disclosure.

FIG. 13 is a schematic view illustrating another bid step according to the first modification example of the present disclosure.

FIG. 14 is a flowchart illustrating a user interface implementation method for participating in a live auction according to a second modification example of the present disclosure.

FIG. 15 is a schematic view illustrating a screen display step according to a second modification example of the present disclosure.

FIG. 16 is a schematic view illustrating a touch step according to the second modification example of the present disclosure.

FIG. 17 is a schematic view illustrating a swipe step according to the second modification example of the present disclosure.

FIG. 18 is a schematic view illustrating a bid step according to the second modification example of the present disclosure.

FIG. 19 is a schematic view illustrating a live auction service system including a participation application module, according to a modification example of the present disclosure.

FIG. 20 is a schematic diagram illustrating a bid price determination reinforcement learning module according to an embodiment of the present disclosure.

FIG. 21 is a schematic diagram illustrating a participant bid possibility generation artificial neural network module according to an embodiment of the present disclosure.

FIG. 22 is a schematic diagram illustrating a successful-bid possibility generation artificial neural network module according to an embodiment of the present disclosure.

### DETAILED DESCRIPTION

Hereinafter, embodiments will be described in detail with reference to the accompanying drawings such that those skilled in the art to which the present disclosure belongs can easily implement the present disclosure. However, in describing in detail operating principles of the preferred embodiments of the present disclosure, when it is determined that a detailed description of a related known function or configuration unnecessarily obscure the subject matter of the present disclosure, the detailed descriptions are omitted.

In addition, the same reference numerals are used for components having similar functions and operations throughout the drawings. Herein, when it is described that a certain portion is connected to another portion, this includes not only a case of direct connection thereto but also a case of indirect connection thereto with another element interposed therebetween. In addition, including a certain component means that other components may be further included therein not excluding other components unless otherwise stated.

Hereinafter, swipe and slide are used interchangeably for the sake of convenience of description, and swipe and slide can mean continuous movement of a contact with a touch screen, and the terms do not limit the scope of the present disclosure.

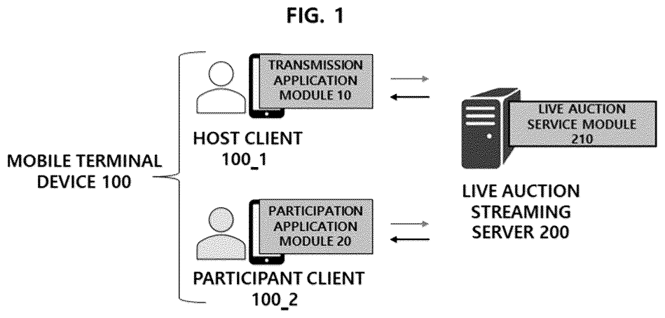

In relation with a live auction service system, FIG. 1 is a schematic view illustrating a live auction service device according to an embodiment of the present disclosure. As illustrated in FIG. 1, a live auction service system according to an embodiment of the present disclosure includes a mobile terminal device 100 including a host client 100_1 and a participant client 100_2, and a live auction streaming server 200 connected to the mobile terminal device 100 through a wired network or a wireless network.

The host client 100_1 refers to a client of a host that transmits a live auction and may include a transmission application module 10 that generates live auction image information through a camera module, transmits the generated live auction image information to the live auction streaming server 200, and implements a user interface of the live auction transmission.

The participant client 100_2 refers to a client of a participant participating in a live auction and may include a participation application module 20, which receives live auction image information through the live auction streaming server 200 and implements a user interface for live auction participation, according to an embodiment of the present disclosure.

The live auction streaming server 200 may indicate a streaming server that streams live auction video information received from the host client 100_1 to the participant client 100_2 and may include a live auction service module 210 that communicates with the transmission application module 10 of the host client 100_1 and the participation application module 20 of the participant client 100_2 to perform a live auction service.

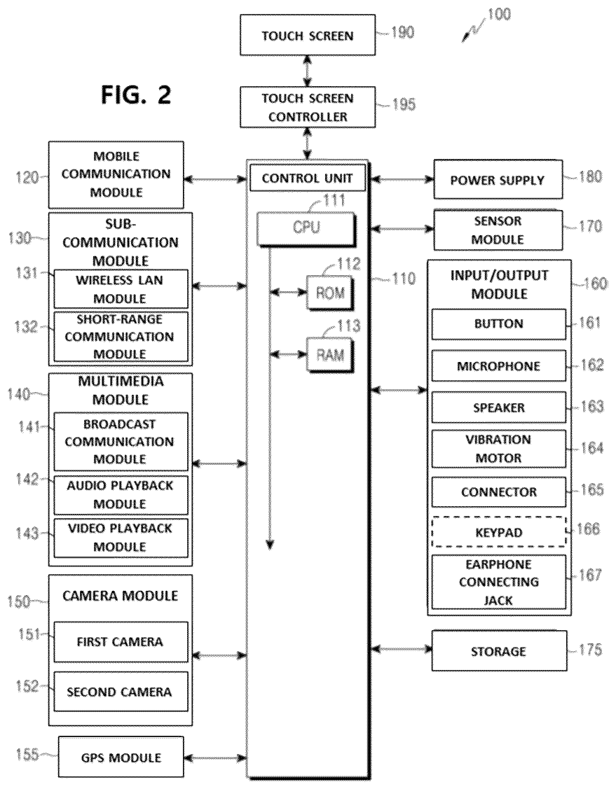

FIG. 2 is a configuration diagram of the mobile terminal device 100 including the participant client 100_2 that performs a user interface implementation operation for live auction, according to an embodiment of the present disclosure. As illustrated in FIG. 2, the mobile terminal device 100 may include a control unit 110, a mobile communication module 120, a sub-communication module 130, a multimedia module 140, a camera module 150, a global positioning system (GPS) module 155, an input/output module 160, a sensor module 170, a storage 175, a power supply 180, and a display 190. The sub-communication module 130 may include at least one of a wireless local area network (LAN) module 131 and a short-range communication module 132, and the multimedia module 140 may include a broadcast communication module 141, an audio playback module 142, and a video playback module 143. The camera module 150 may include at least one of a first camera 151 and a second camera 152, and the input/output module 160 (also referred to as an input/output unit) may include at least one of a plurality of buttons 161, a microphone 162, a speaker 163, a vibration motor 164, a connector 165, a keypad 166, and an earphone connecting jack 167. Hereinafter, a case in which the display 190 and a display controller 195, which are respectively referred to as a touch screen 190 and a touch screen controller 195, will be described as an example.

The power supply 180 may supply power to one or a plurality of batteries (not illustrated) arranged in a housing of the mobile terminal device 100 under control by the control unit 110. One or the plurality of batteries (not illustrated) may supply power to the mobile terminal device 100. In addition, the power supply 180 may supply power input from an external power source (not illustrated) to the mobile terminal device 100 through a wire cable connected to the connector 165. In addition, the power supply 180 may also supply the power wirelessly input from an external power source to the mobile terminal device 100 through wireless charging technology.

The camera module 150 may include at least one of the first camera 151 and the second camera 152 that captures still images or videos under control by the control unit 110.

The multimedia module 140 may include the broadcast communication module 141, the audio playback module 142, and the video playback module 143. The broadcast communication module 141 may receive a broadcast signal (for example, a television (TV) broadcast signal, a radio broadcast signal, or a data broadcast signal) and broadcast addition information (for example, electric program guide (EPS) or electric service guide (ESG)) transmitted from a broadcasting station through a broadcast communication antenna (not illustrated) under control by the control unit 110 The audio playback module 142 may play back the stored or received digital audio file (for example, a file having a file extension of mp3, wma, ogg, or way) under control by the control unit 110. The video playback module 143 may play back the stored or received digital video file (for example, a file having a file extension of mpeg, mpg, mp4, avi, mov, or mkv) under control by the control unit 110. The video playback module 143 can play back a digital audio file.

The multimedia module 140 may include the audio playback module 142 and the video playback module 143 except for the broadcast communication module 141. In addition, the audio playback module 142 or the video playback module 143 of the multimedia module 140 may be included in the control unit 110.

The mobile communication module 120 may connect the mobile terminal device 100 to an external device through mobile communication using at least one or a plurality of antennas (not illustrated) under control by the control unit 110. The mobile communication module 120 can transmit and receive wireless signals for a voice call, a video call, a text message (short message service (SMS)) or a multimedia message (MMS) to and from a mobile phone (not illustrated) having a phone number input to the mobile terminal device 100, a smartphone (not illustrated), a tablet personal computer (PC), or another device (not illustrated) and. In addition, the mobile communication module 120 may be connected to a wireless Internet or so on at a place where a wireless access point (AP) is installed through a Wi-Fi, a 3 generation (3G) data network, or a four generation (4G) data network or may transmit and receive wirelessly wireless signals to and from peripheral devices under control of the control unit 110.

The sub-communication module 130 may include at least one of the wireless LAN module 131 and the short-range communication module 132.

The wireless LAN module 131 may be connected to the Internet at a place where the wireless access point (AP) (not illustrated) is installed under control of the control unit 110. The wireless LAN module 131 supports a wireless LAN standard (IEEE802.11x) of the Institute of Electrical and Electronics Engineers (IEEE). The short-range communication module 132 may wirelessly perform a short-range communication with the control unit 110 in the mobile terminal device 100.

The mobile terminal device 100 may include at least one of the mobile communication module 120, the wireless LAN module 131, and the short-range communication module 132 depending on performance. For example, the mobile terminal device 100 may include a combination of the mobile communication module 120, the wireless LAN module 131, and the short-range communication module 132 depending on performance.

The GPS module 155 may receive radio waves from a plurality of GPS satellites (not illustrated) on earth orbit and may calculate a position of the mobile terminal device 100 by using the time of arrival of the radio wave from the plurality of GPS satellites (not illustrated) to the mobile terminal device 100.

The sensor module 170 includes at least one sensor that detects a state of the mobile terminal device 100. For example, the sensor module 170 may include a proximity sensor for detecting whether a user approaches the mobile terminal device 100, a motion sensor (not illustrated) for detecting an operation (for example, rotation of the mobile terminal device 100, acceleration or vibration applied to the mobile terminal device 100) of the mobile terminal device 100, an illuminance sensor (not illustrated) for detecting the amount of ambient light, a gravity sensor for detecting a direction of gravity, or an altimeter for detecting altitude by measuring atmospheric pressure. In addition, the sensor module 170 may include a geomagnetic sensor (not illustrated) for detecting a point of the compass by using a magnetic field of the earth, and an inertial sensor for measuring an angular displacement or a change rate of the angular displacement in a certain direction.

Sensors of the sensor module 170 may be added or removed depending on performance of the mobile terminal device 100. At least one sensor may detect a state, generate a signal corresponding to the detection, and transmit the signal to the control unit 110.

The input/output module 160 (also referred to as an input/output unit) may include at least one of the plurality of buttons 161, the microphone 162, the speaker 163, the vibration motor 164, the connector 165, and the keypad 166.

The plurality of buttons 161 may be formed on a front surface, a side surface, or a rear surface of the housing of the mobile terminal device 100 and may include at least one of a power/lock button (not illustrated), a volume button (not illustrated), a menu button, a home button, a back button, and a search button 161.

The microphone 162 may receive voice or sound and generate an electrical signal under control by the control unit 110.

One or a plurality of speakers 163 may be formed at an appropriate position or positions of the housing of the mobile terminal device 100. The speaker 163 may output, to the outside of the mobile terminal device 100, sound corresponding to various signals (for example, a wireless signal, a broadcast signal, a digital audio file, a digital video file, a captured image, and so on) of the mobile communication module 120, the sub-communication module 130, the multimedia module 140, or the camera module 150 under control by the control unit 110. The speaker 163 may output sound (for example, button operation sound corresponding to a phone call or a ring back sound) corresponding to a function performed by the mobile terminal device 100.

The vibration motor 164 may convert an electrical signal into a mechanical vibration under control by the control unit 110. For example, when receiving a voice call from another device (not illustrated), the mobile terminal device 100 in vibration mode operates the vibration motor 164. One or a plurality of vibration motors 164 may be provided in the housing of the mobile terminal device 100. The vibration motor 164 may operate in response to a touch operation of a user which touches the touch screen 190 and a continuous movement of the touch on the touch screen 190.

The connector 165 may be used as an interface for connecting the mobile terminal device 100 to an external device (not illustrated) or a power source (not illustrated). The mobile terminal device 100 may transmit data stored in the storage 175 of the mobile terminal device 100 to an external device (not illustrated) through a wire cable connected to the connector 165 under control by the control unit 110 or may receive data from the external device (not illustrated). In addition, the mobile terminal device 100 may receive power from a power source (not illustrated) through a wire cable connected to the connector 165 or may charge a battery (not illustrated) by using the power source.

The keypad 166 may receive a key input from a user to control the mobile terminal device 100. The keypad 166 may include a physical keypad (not illustrated) formed in the mobile terminal device 100 or a virtual keypad (not illustrated) displayed on the touch screen 190. The physical keypad (not illustrated) formed in the mobile terminal device 100 may be excluded depending on performance or a structure of the mobile terminal device 100.

An earphone (not illustrated) may be inserted into the earphone connecting jack 167 and connected to the mobile terminal device 100.

The touch screen 190 may receive a user's manipulation and display an execution image, an operation state, and a menu state of an application program. That is, the touch screen 190 may provide a user interface corresponding to various services (for example, a call, data transmission, broadcast, and photography) to a user. The touch screen 190 may transmit an analog signal corresponding to at least one touch input to the user interface to the touch screen controller 195. The touch screen 190 may receive at least one touch through a user's body (for example, a finger including a thumb) or touchable input means (for example, a stylus pen). In addition, the touch screen 190 may receive a continuous motion of one touch among the at least one touch. The touch screen 190 may transmit an analog signal corresponding to the continuous movement of an input touch to the touch screen controller 195.

In addition, according to the present disclosure, the touch is not limited to direct contact between the touch screen 190 and a user's body or a touchable input means, and may include non-contact. An interval detectable by the touch screen 190 may be changed depending on performance or a structure of the mobile terminal device 100, and in particular, the touch screen 190 may output different values (for example, a current value and so on) detected by a touch event and a hovering event such that the touch event due to a contact with a user's body or touchable input means and an input event in a non-contact state (for example, hovering) may be detected to be distinguished. In addition, the touch screen 190 may preferably output different detected values (for example, a current value and so on) depending on a distance between the touch screen 190 and a space where the hovering event occurs.

The touch screen 190 may be implemented by, for example, a resistive method, a capacitive method, an electromagnetic induction (EMR) method, an infrared method, or an acoustic wave method.

Meanwhile, the touch screen controller 195 may convert an analog signal received from the touch screen 190 into a digital signal (for example, X and Y coordinates) and transmit the converted signal to the control unit 110. The control unit 110 may control the touch screen 190 by using the digital signal received from the touch screen controller 195. For example, the control unit 110 may select a shortcut icon (not illustrated) displayed on the touch screen 190 or execute the shortcut icon (not illustrated) in response to the touch event or the hovering event. In addition, the touch screen controller 195 may also be included in the control unit 110.

In addition, the touch screen controller 195 may detect a value (for example, a current value or so on) output through the touch screen 190 to check a distance between the touch screen 190 and a space where the hovering event occurs, and may convert the checked distance value into a digital signal (for example, Z coordinate) and provide the converted value to the control unit 110.

In addition, the touch screen 190 may include at least two touch screen panels capable of respectively detecting touch or proximity of a user's body and touchable input means so as to simultaneously receive an input from the user's body and the touchable input means. The at least two touch screen panels may provide different output values to the touch screen controller 195, and the touch screen controller 195 may recognize differently the values input from the at least two touch screen panels and distinguish whether the values input from the at least two touch screen panels are input by a user's body or by touchable input means.

The storage 175 may store signals or data input or output to correspond to operations of the mobile communication module 120, the sub-communication module 130, the multimedia module 140, the camera module 150, the GPS module 155, the input/output module 160, the sensor module 170, and the touch screen 190 under control by the control unit 110. The storage 175 may store a control program and an applications for controlling the mobile terminal device 100 or the control unit 110.

A term “storage” may include the storage 175, a read only memory (ROM) 112 or a random access memory (RAM) 113 in the control unit 110, or a memory card (not illustrated) (for example, a secure digital (SD) card or a memory stick) mounted in the mobile terminal device 100. The storage may include a non-volatile memory, a volatile memory, a hard disk drive (HDD), or a solid state drive (SSD).

The control unit 110 may include a central processing unit (CPU) 111, the ROM 112 in which a control program for controlling the mobile terminal device 100 is stored, and the RAM 113 that stores a signal or data input from the outside of the mobile terminal device 100 and is used as a storage area for an operation performed by the terminal device 100. The CPU 111 may include a single core, a dual core, a triple core, or a quad core. The CPU 111, the ROM 112, and the RAM 113 may be connected to one another through an internal bus.

The control unit 110 may control the mobile communication module 120, the sub-communication module 130, the multimedia module 140, the camera module 150, the GPS module 155, the input/output module 160, the sensor module 170, the storage 175, the power supply 180, the touch screen 190, and the touch screen controller 195.

In addition, when there is an input to a first item among one or more setting items of an operation window displayed on the touch screen 190 according to an input through the touch screen 190, the control unit 110 may control at least a part or the rest, in which the first item is excluded, of the operation window displayed on the touch screen 190 so as not to be displayed on the touch screen 190 according to characteristics of a user interface display operation of the present disclosure. In addition, after performing an operation of not displaying, on the touch screen 190, at least a part or the rest, in which the first item is excluded, of the operation window displayed on the touch screen 190, when inputting to the first item is finished, the control unit 110 may control at least a part or the rest, in which the first item is excluded, of the operation window displayed on the touch screen 190 to be displayed on the touch screen 190 again.

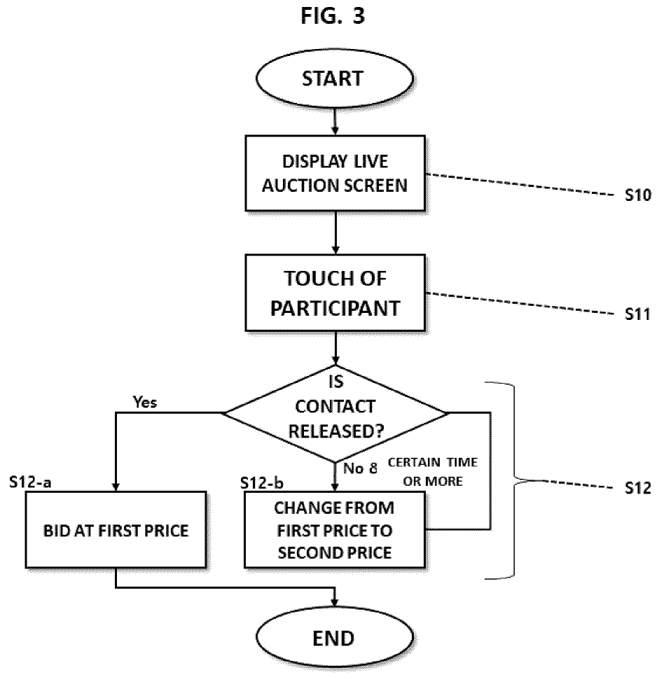

FIG. 3 is a flowchart of a user interface implementation method for participating in a live auction, according to one embodiment of the present disclosure. Referring to FIG. 3, a user interface implementation method for participating in a live auction which is implemented by the participation application module 20 of the participant client 100_2, according to an embodiment of the present disclosure, may include a screen display step S10, a touch step S11, and a bid step S12.

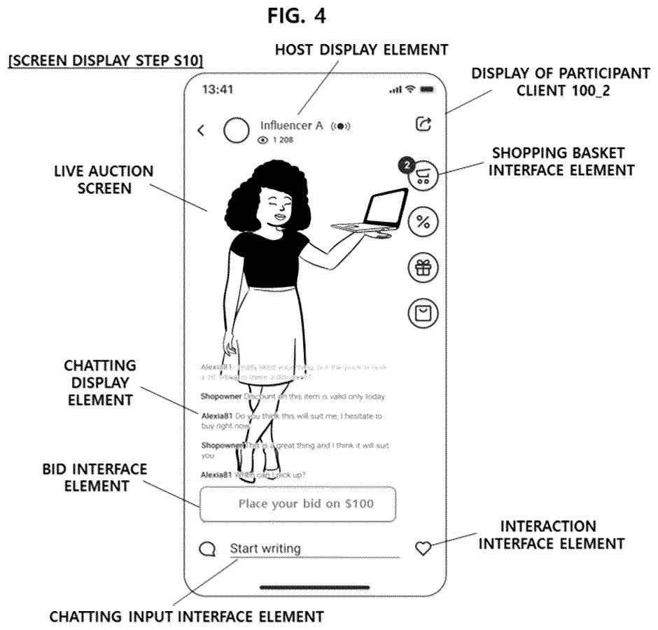

In relation to the screen display step S10, FIG. 4 illustrates a schematic view of the screen display step S10 according to the embodiment of the present disclosure. As illustrated in FIG. 4, in the screen display step S10, the participation application module of the participant client 100_2 receives live auction video information from the live auction streaming server 200, and a live auction screen on which the live auction video information is displayed is displayed on a screen display of the participant client 100_2. Display of the live auction screen in the screen display step is configured to be maintained even in the steps below. As illustrated in FIG. 4, in the screen display step S10, the live auction screen displayed on the display of the participant client 100_2 may include a host display element for identifying a host, a chatting display element for displaying live chatting, a shopping cart interface element that performs movement of a participant to a shopping cart page, a chatting input interface element for that performs a keyboard output for a chatting input of the participant, an interaction interface element for inputting interaction information of the participant, and a bid interface element for performing the touch step S11 and the bid step S12 below.

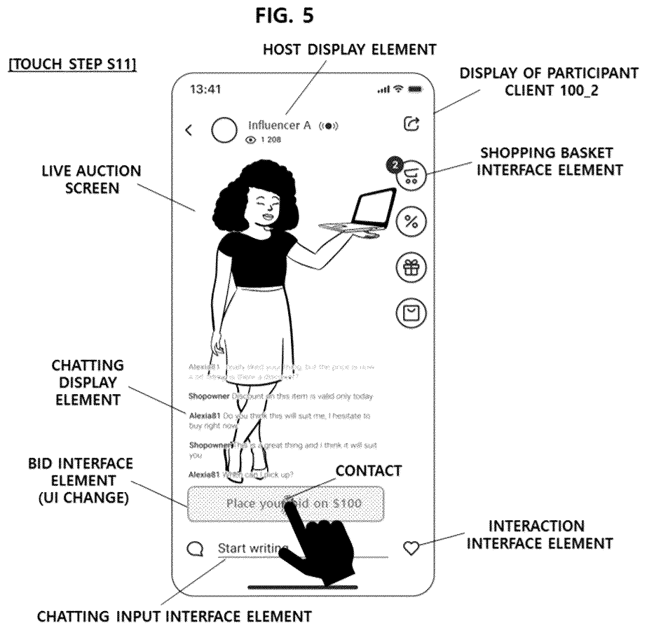

In relation to the touch step S11, FIG. 5 illustrates a schematic view of the touch step S11 according to the embodiment of the present disclosure. As illustrated in FIG. 5, in the touch step S11, a participant comes into contact with a touch-sensitive surface at a certain position on the display of the participant client 100_2, and the participant client 100_2 detects the contact with the certain position on the touch-sensitive surface. As illustrated in FIG. 5, in the touch step S11, the live auction screen displayed on the display of the participant client 100_2 may be configured to display a change (for example, a color change, a size change, a position change, or so on) in the bid interface element as an output for detecting a participant's contact with the bid interface element.

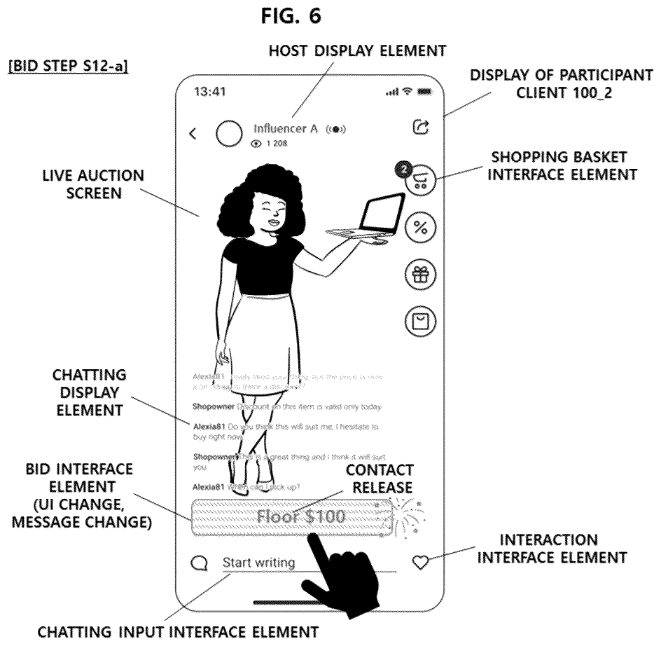

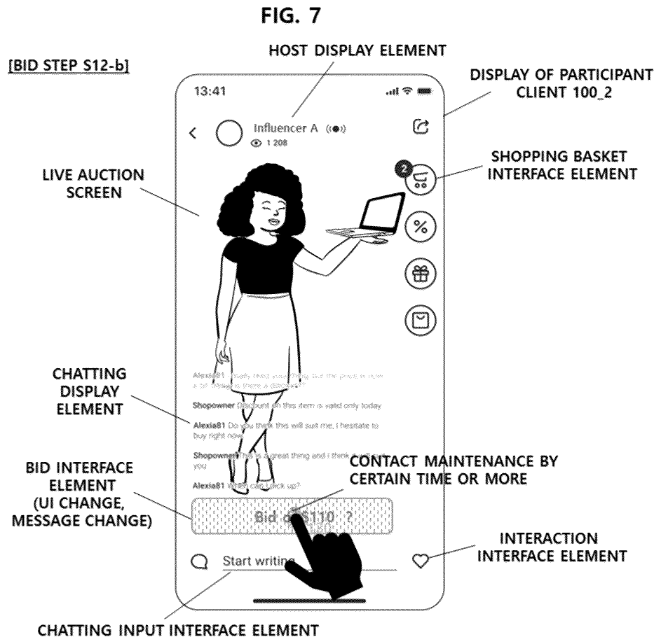

In relation to the bid step S12, FIG. 6 illustrates a schematic view of a bid step S12-a according to the embodiment of the present disclosure, and FIG. 7 is a schematic view illustrating a bid step S12-b according to an embodiment of the present disclosure. As illustrated in FIGS. 6 and 7, in the bid step S12, when a participant releases the contact, a first function (bid at a first price) of the participation application module 20 is performed (S12-a), and when the participant maintains the contact for a certain period of time or more, a second function (a change of the first price to the second price) of the participation application module 20 is performed (S12-b). Accordingly, according to one embodiment of the present disclosure, an operation window that can be changed by a participant and a screen on which an operation is reflected are provided at the same time. For example, when the participant releases the contact in a state where the first price is 1,000 won, a bid at the first price of 1,000 won is input to the participation application module 20 (S12-a). In addition, when the participant maintains the contact for a certain time or longer in a state where the first price is 1,000 won, the first price, which was 1,000 won, is changed to 2,000 won (the second price) (S12-b), and when the participant releases the contact in this state, a bid at the changed first price of 2,000 won is input to the participation application module 20 (S12-a). In addition, the second function may perform a change to the second price that is greatly different from the first price in proportion to maintenance time of the contact. For example, when the first price of 1,000 won is maintained for 1 sec, the first price may be changed to 2,000 won (the second price), and when the first price is maintained for 2 sec, the first price may be changed to 3,000 won (a third price). As illustrated in FIG. 6, in the bid step S12-a, the live auction screen displayed on the display of the participant client 100_2 may be configured to display a change (for example, a color change, a size change, a position change, or so on) in the bid interface element and/or a change (for example, a change from “place your bid on $000” to “floor $000”, or so on) in a message of the bid interface element as an output for detecting a participant's contact release for the bid interface element. In addition, as illustrated in FIG. 7, in the bid step S12-b, the live auction screen displayed on the display of the participant client 100_2 may be configured to display a change (for example, a color change, a size change, a position change, or so on) in the bid interface element and/or a change (for example, a change from “place your bid on $000” to “floor $000”, or so on) in a message of the bid interface element as an output for detecting the participant's contact maintenance for the bid interface element for a certain time or more (for example, 1 sec or more).

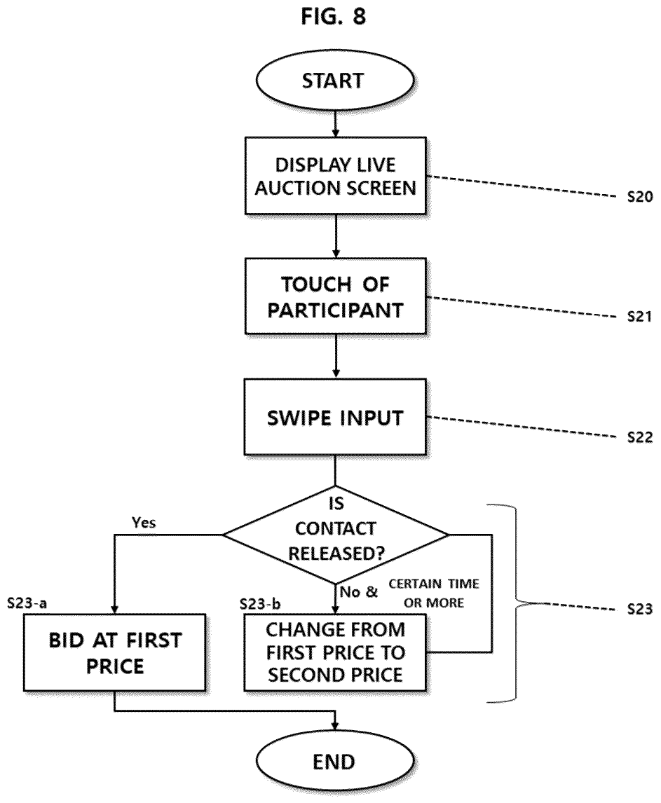

FIG. 8 is a flowchart of a user interface implementation method for participating in a live auction, according to a first modification example of the present disclosure. Referring to FIG. 8, the user interface implementation method for participating in a live auction which is implemented by the participation application module 20 of the participant client 100_2, according to the first modification example of the present disclosure, may include a screen display step S20, a touch step S21, a swipe step S22, and a bid step S23.

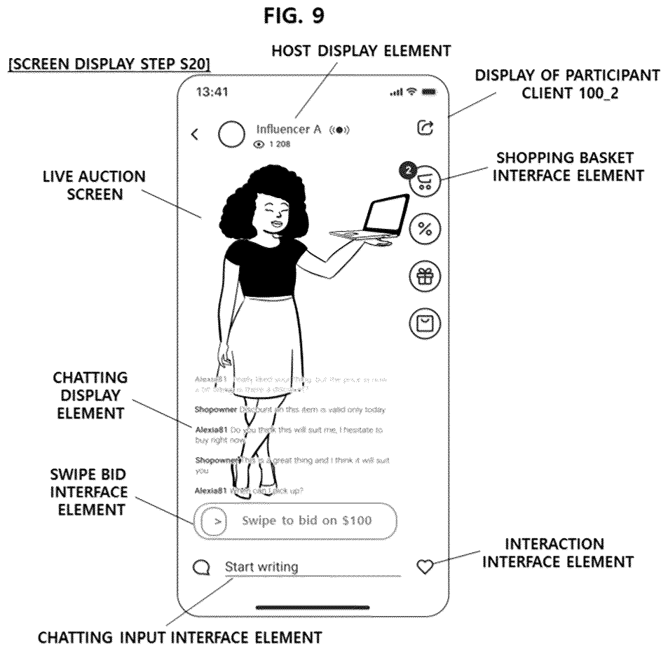

In relation to the screen display step S20, FIG. 9 illustrates a schematic view of the screen display step S20 according to the first modification example of the present disclosure. As illustrated in FIG. 9, in the screen display step S20, the participation application module 20 of the participant client 100_2 receives live auction video information from the live auction streaming server 200, and a live auction screen on which the live auction video information is displayed is displayed on a touch screen display of the participant client 100_2. Display of the live auction screen in the screen display step is configured to be maintained even in the steps below. As illustrated in FIG. 9, the live auction screen that is displayed on the display of the participant client 100_2 in the screen display step (S20) may include a host display element for identifying a host, a chatting display element for displaying live chatting, a shopping cart interface element that performs movement of a participant to a shopping cart page, a chatting input interface element for that performs a keyboard output for a chatting input of the participant, an interaction interface element for inputting interaction information of the participant, and a swipe bid interface element for performing the touch step S21, the swipe step S22, and the bid step S23 below.

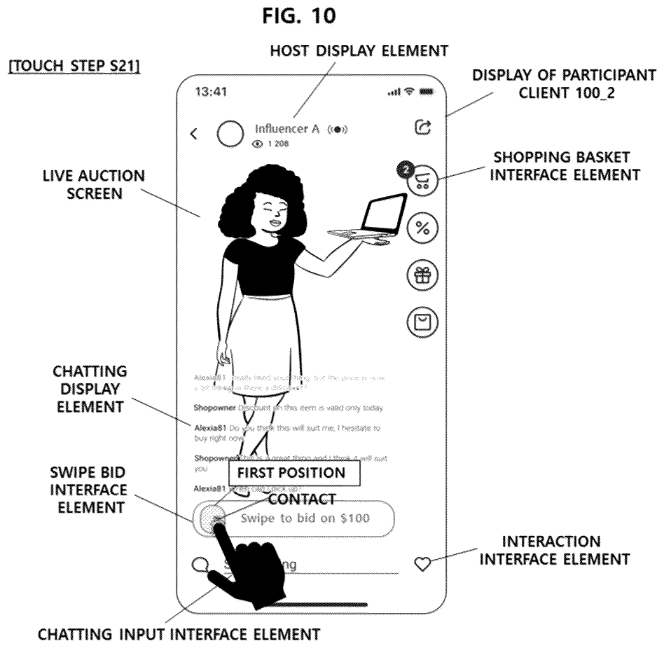

In relation to the touch step S21, FIG. 10 illustrates a schematic view of the touch step S21 according to the first modification example of the present disclosure. As illustrated in FIG. 10, in the touch step S21, a participant performs a first input, which is a contact with a touch-sensitive surface at a first position on the display of the participant client 100_2, and the participation application module 20 receives the first input. In this case, a start portion of a slider, which is a user interface element in the form of a slider in a certain direction, may be displayed at the first position on the display in the touch step S21. In the touch step S21, the live auction screen that is displayed on the display of the participant client 100_2 may be configured to display a change (for example, a color change, a size change, a position change, or so on) in the swipe bid interface element as an output for detecting a participant's contact with the first position of the swipe bid interface element.

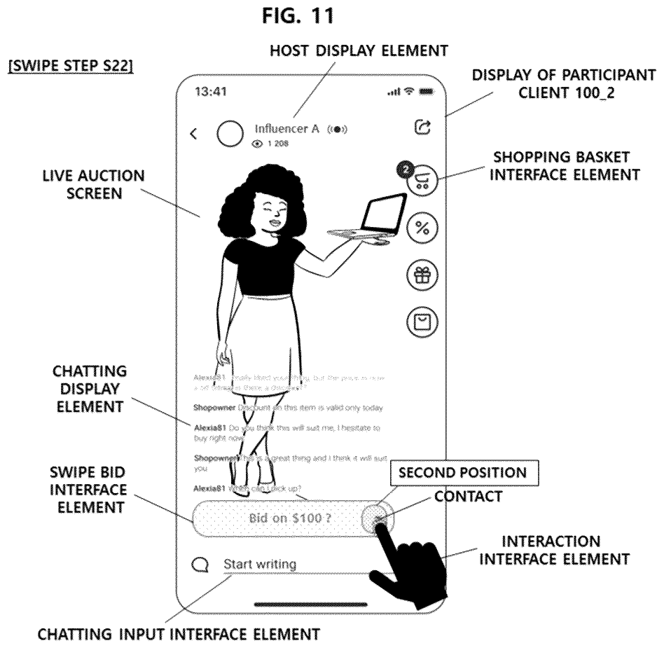

In relation to the swipe step S22, FIG. 11 illustrates a schematic view of the swipe step S22 according to the first modification example of the present disclosure. As illustrated in FIG. 11, in the swipe step S22, a participant performs a second input, which is a gesture including a continuous movement of the contact from a first position on the display of the participant client 100_2 to a second position without releasing the contact with the touch-sensitive surface, and the participation application module 20 receives the second input. In this case, an end portion of a slider, which is a user interface element in the form of the slider in a certain direction, may be displayed at the second position on the display in the swipe step. In the swipe step S22, the live auction screen that is displayed on the display of the participant client 100_2 may be configured to display a change (for example, a color change, a size change, a position change, or so on) in the swipe bid interface element and/or a change (for example, a change from “place your bid on $000” to “bid on $000 ?”, or so on) in the swipe bid interface element as an output for detecting a participant's continuous movement from the first position to the second position for the swipe bid interface element.

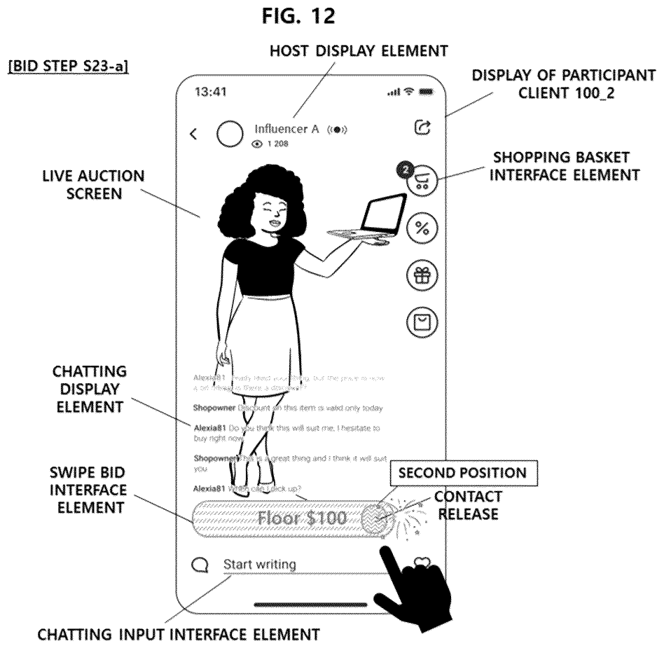

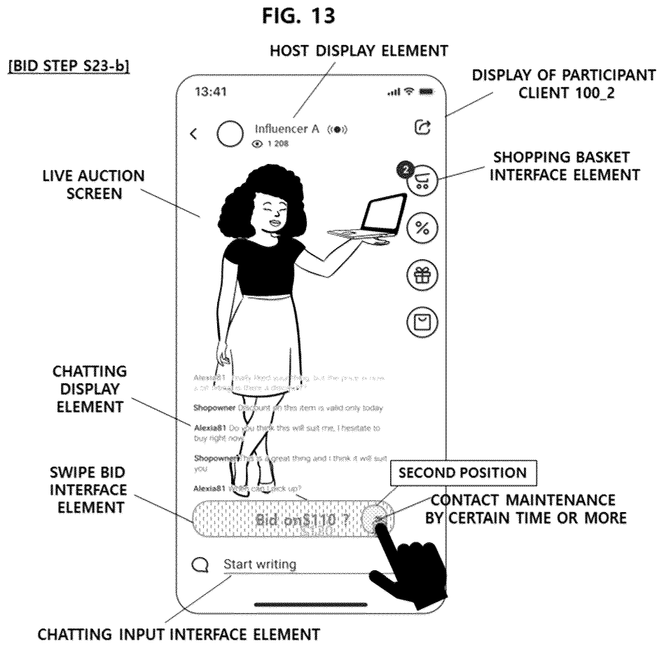

In relation to the bid step S23, FIG. 12 illustrates a schematic view of a bid step S23-a according to the present disclosure, and FIG. 13 illustrates a schematic view of a bid step S23-b according to an embodiment of the present disclosure. As illustrated in FIGS. 12 and 13, in the bid step S23, when a participant releases the contact at the second position after the swipe step, a first function (bid at a first price) of the participation application module 20 is performed, and when the participant maintains the contact at the second position for a certain time or more, a second function (a change from the first price to a second price) of the participation application module 20 is performed. Accordingly, according to one embodiment of the present disclosure, an operation window that can be changed by a participant and a screen on which an operation is reflected are simultaneously provided. For example, when the participant releases the contact after swipe in a state where the first price is 1,000 won, a bid at the first price of 1,000 won is input to the participation application module 20. In addition, when a participant maintains a contact for a certain time or more after swipe in a state where the first price is 1,000 won and, the first price, which was 1,000 won, is changed to 2,000 won (a second price), and when the participant releases the contact In this state, a bid at the changed first price of 2,000 won is input to the participation application module 20. In this case, the second price may indicate a price relatively close to a successful bid than the first price, and in the case of a high-price successful bid, the second price is higher than the first price, and in the case of a low-price successful bid, the second price is lower than the first price. In addition, in the bid step, when the first function is performed, a bid message, which is a user interface element in the form of a message for a bid at the first price, may be displayed on a certain position of the display. In addition, the second function may perform a change to the second price that is greatly different from the first price in proportion to maintenance time of the contact. For example, when the first price of 1,000 won is maintained for 1 sec, the first price may be changed to 2,000 won (the second price), and when the first price is maintained for 2 sec, the first price may be changed to 3,000 won (a third price). In the bid step S23-a, the live auction screen displayed on the display of the participant client 100_2 may be configured to display a change (for example, a color change, a size change, a position change, or so on) in the bid interface element and/or a change (for example, a change from “place your bid on $000” to “floor $000”, or so on) in a message of the bid interface element as an output for detecting a participant's contact release for the bid interface element. In addition, in the bid step S23-b, the live auction screen displayed on the display of the participant client 100_2 may be configured to display a change (for example, a color change, a size change, a position change, or so on) in the swipe bid interface element and/or a change (for example, a change from “place your bid on $000” to “floor $000”, or so on) in a message of the swipe bid interface element as an output for detecting the participant's contact maintenance for the bid interface element for a certain time or more (for example, 1 sec or more).

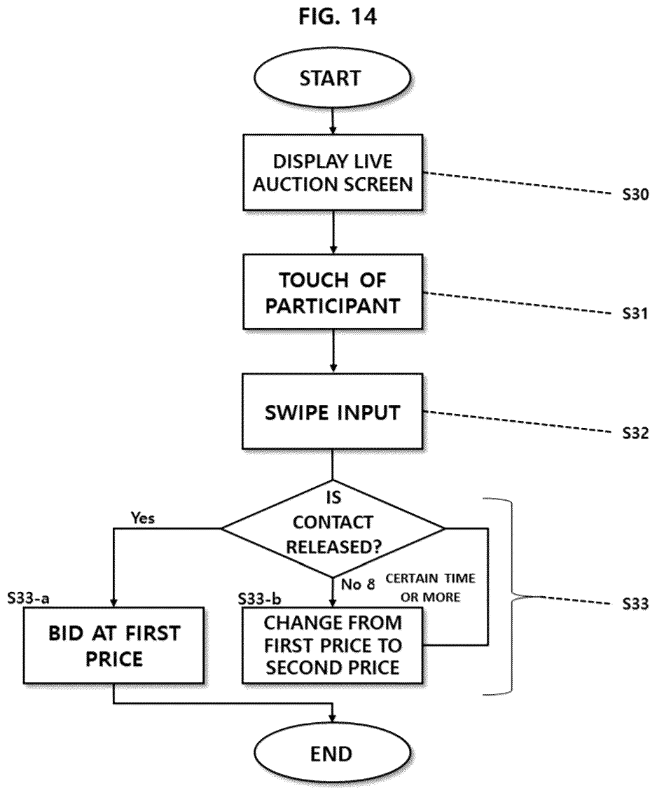

FIG. 14 is a flowchart of a user interface implementation method for participating in a live auction, according to a second modification example of the present disclosure. Referring to FIG. 14, a user interface implementation method for participating in a live auction which is implemented by the participation application module 20 of the participant client 100_2, according to a second modification example of the present disclosure, may include a screen display step S30, a touch step S31, a swipe step S32, and a bid step S33.

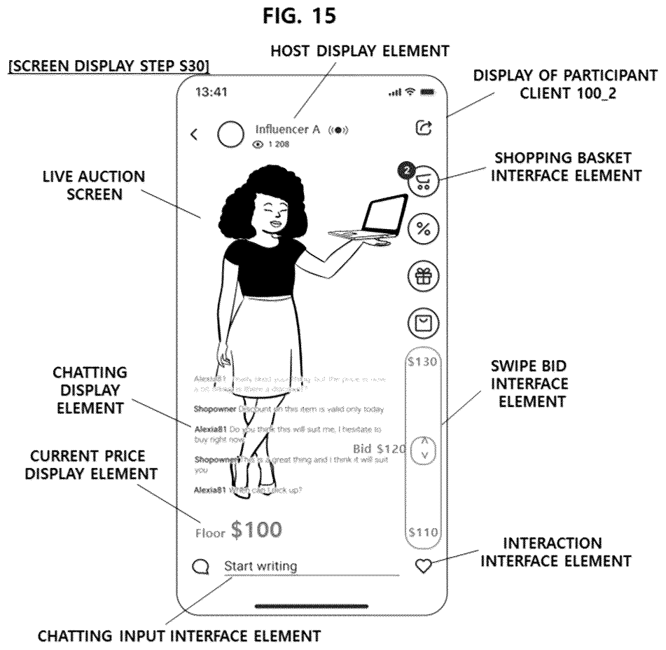

In relation to the screen display step S30, FIG. 15 illustrates a schematic view of the screen display step S30 according to the second modification example of the present disclosure. As illustrated in FIG. 15, in the screen display step S30, the participation application module 20 of the participant client 100_2 receives live auction video information from the live auction streaming server 200, and a live auction screen on which the live auction video information is displayed on a touch screen display of the participant client (100_2). The display of the live auction screen in the screen display step is configured to be maintained even in the steps below. In the screen display step S30, the live auction screen that is displayed on the display of the participant client 100_2 may include a host display element for identifying a host, a chatting display element for displaying live chatting, a shopping cart interface element that performs movement of a participant to a shopping cart page, a chatting input interface element for that performs a keyboard output for a chatting input of the participant, an interaction interface element for inputting interaction information of the participant, a current price display element, and a swipe bid interface element for performing the touch step S31, the swipe step S32, and the bid step S33 below.

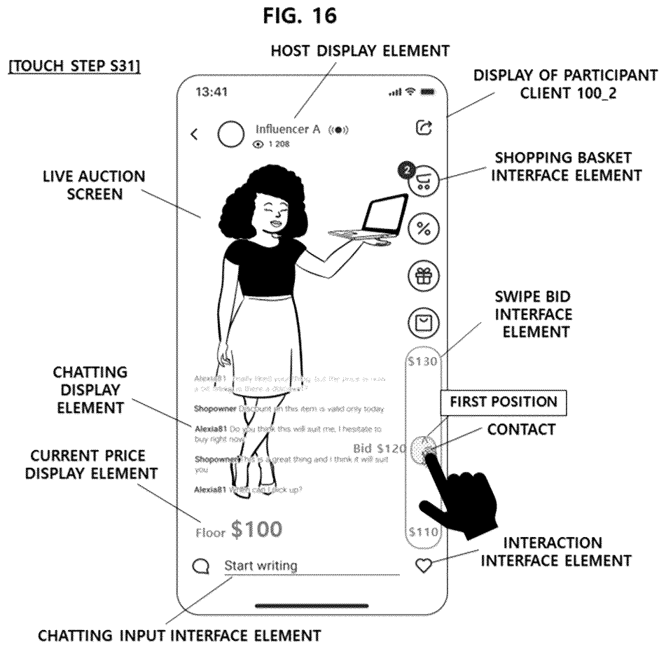

In relation to the touch step S31, FIG. 16 illustrates a schematic view of the touch step S31 according to the second modification example of the present disclosure. As illustrated in FIG. 16, in the touch step S31, a participant performs a first input, which is a contact with a touch-sensitive surface at a first position on the display of the participant client 100_2, and the participation application module 20 receives the first input. In the touch step S31, the live auction screen that is displayed on the display of the participant client 100_2 may be configured to display a change (for example, a color change, a size change, a position change, or so on) in the swipe bid interface element as an output for detecting a participant's contact with the first position of the swipe bid interface element.

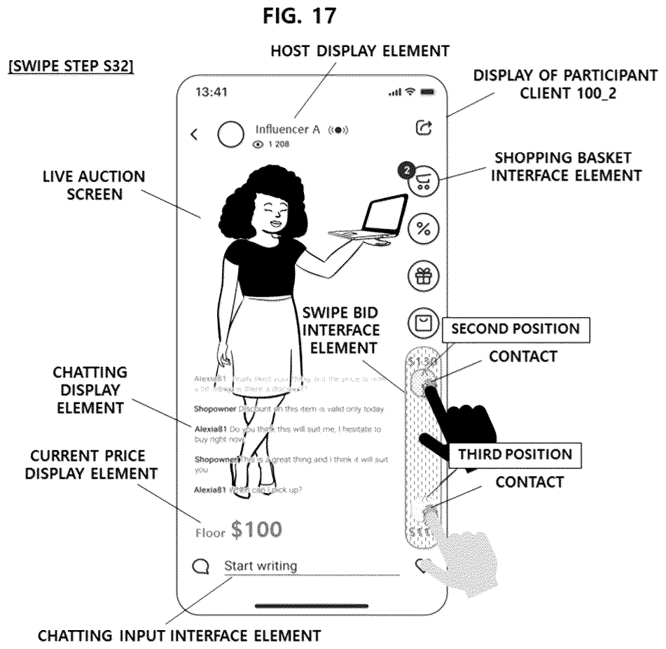

In relation to the swipe step S32, FIG. 17 illustrates a schematic view of the swipe step S32 according to the second modification example of the present disclosure. As illustrated in FIG. 17, in the swipe step S32, a participant performs a second input, which is a gesture including a continuous movement of the contact from a first position on the display of the participant client 100_2 to a second position without releasing the contact with the touch-sensitive surface, the participation application module 20 receives the second input and performs a second function (a change from a first price to a second price higher than the first price), or the participant performs a third input, which is a gesture including a continuous movement of the contact from the first position on the display of the participant client 100_2 to a third position without releasing the contact with the touch-sensitive surface and performs a third function (a change from the first price to a third price lower than the first price). In this case, the second price may be determined according to a distance difference between the first position and the second position, and the third price may be determined according to a distance difference between the first position and the third position. In the swipe step S32, the live auction screen that is displayed on the display of the participant client 100_2 may be configured to display a change (for example, a color change, a size change, a position change, or so on) in the swipe bid interface element and/or a change (for example, a change from “bid $000” to “$000 ?”, or so on) in the swipe bid interface element as an output for detecting a participant's continuous movement from the first position to the second position or the third position for the swipe bid interface element.

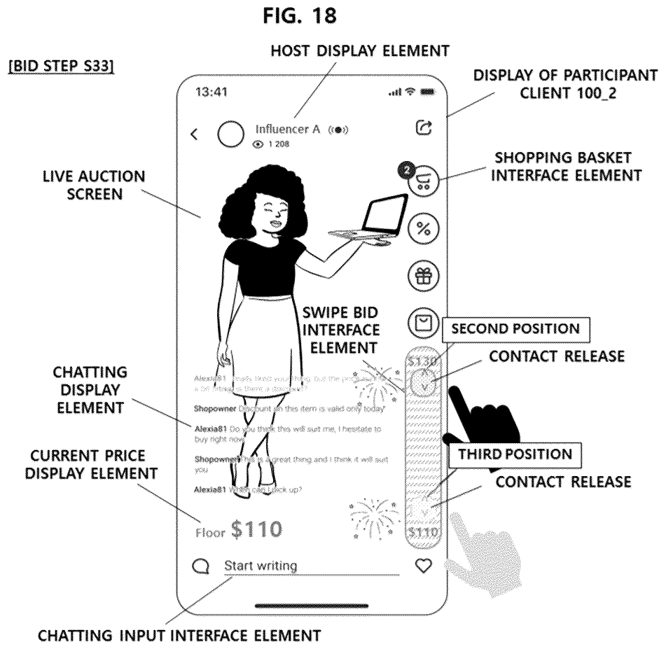

In relation to the bid step S33, FIG. 18 illustrates a schematic view of the bid step S33 according to the second modification example of the present disclosure. As illustrated in FIG. 18, in the bid step S33, when the participant releases the contact after the touch step or the swipe step, the first function (bid at the first price) of the participation application module 20 is performed. For example, when the participant releases the contact after the touch step in a state where the first price is 1,000 won, a bid at the first price of 1,000 won is input to the participation application module 20. In addition, when the participant performs swipe (the second function) to the second position in a state where the first price is 1,000 won, the first price that was 1,000 won is changed to 2,000 won (the second price), and in this state, when the participant performs release (the first function) of the contact, a bid at the changed first price of 2,000 won is input to the participation application module 20. In addition, when the participant performs swipe (third function) to the third position in a state where the first price is 1,000 won, the first price which was 1,000 won is changed to 500 won (a third price), and in this state, when the participant performs release (the first function) of the contact, a bid at the changed first price of 500 won is input to the participation application module 20. In the bid step S33, the live auction screen displayed on the display of the participant client 100_2 may be configured to display a change (for example, a color change, a size change, a position change, or so on) in the swipe bid interface element, a current price display element, and a change in a message of the swipe bid interface element as an output for detecting a participant's contact release for the bid interface element.

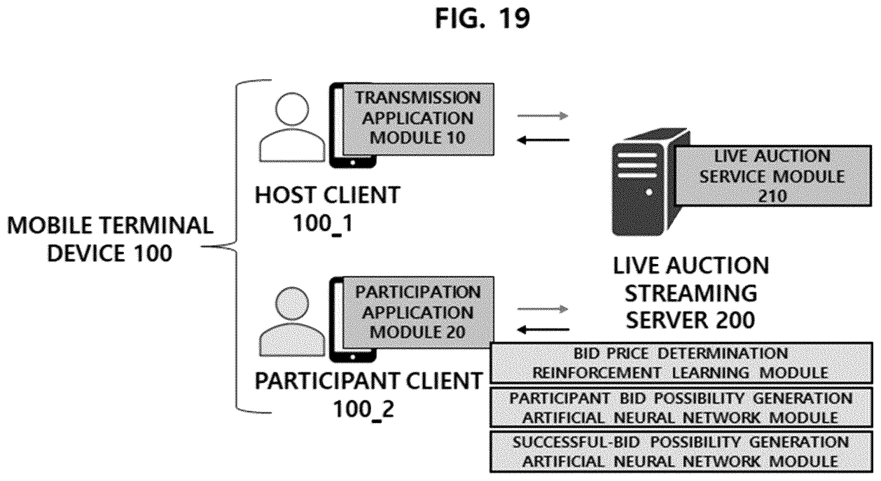

In relation to a modification example of the participation application module 20, FIG. 19 illustrates a schematic view for live auction service system including the participation application module 20, according to the modification example of the present disclosure. As illustrated in FIG. 19, the participation application module 20 according to the modification example of the present disclosure may further include a bid price determination reinforcement learning module, a participant bid possibility generation artificial neural network module, and a successful-bid possibility generation artificial neural network module.

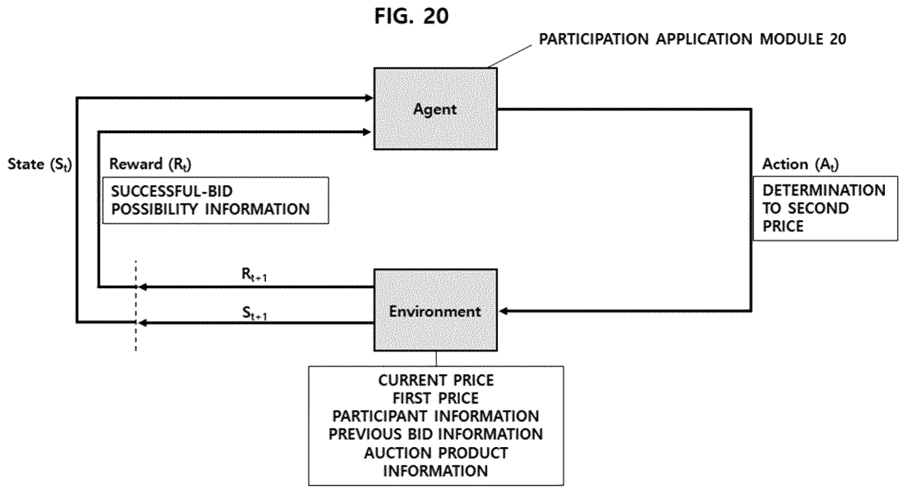

In relation to the bid price determination reinforcement learning module, FIG. 20 illustrates a schematic diagram of the bid price determination reinforcement learning module according to an embodiment of the present disclosure. The bid price determination reinforcement learning module according to an embodiment of the present disclosure may configure an environment as a current price (a floor or a current highest/lowest bid), a first price, participant information, bid information so far, and auction product information (category information, image information, evaluation price information, start-price information, and so on), configure a state as the first price, the number of participants, and a bid rate, configure an agent as the participation application module 20 that performs an output of a second price, configure an action as determination of the second price, and configure reward as successful-bid possibility information. In this case, the participant information may include participant number information to which the number of existing bids divided by the number for live auction participations of each participant are applied as weight values. For example, when there are two participants, A and B, who participate in the current live auction, the number of existing bids of A divided by the number of participations of A in the live auction are 0.2, and the number of existing bids of B divided by the number of participations of B in the live auction are 0.1, the participant number information to which the weight values are applied may be generated as 0.2+0.1=0.3 to be used. In addition, the participant information may include participant bid possibility information, and the participant bid possibility information may be generated by a participant bid possibility generation artificial neural network module.

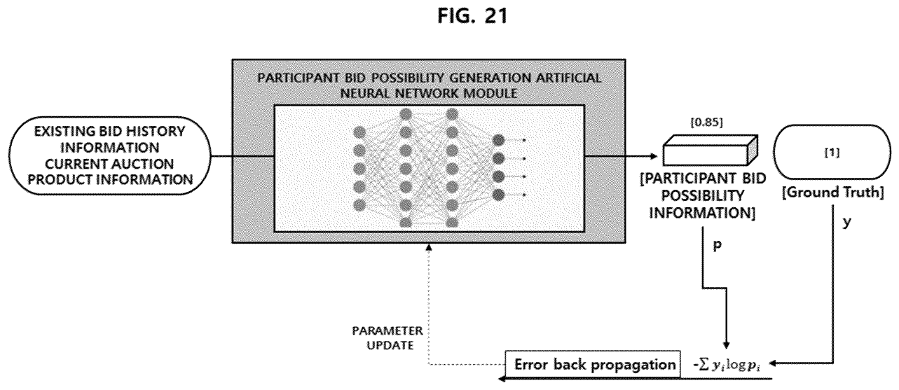

In relation to the participant bid possibility generation artificial neural network module, FIG. 21 illustrates a schematic diagram of the participant bid possibility generation artificial neural network module according to an embodiment of the present disclosure. As illustrated in FIG. 21, the participant bid possibility generation artificial neural network module may be learned in advance to use existing bid history information (existing bid product category information, existing bid product image information, existing bid time information, existing bid product evaluation price information, existing bid product start-price information, and so on) of each participant and current auction product information (current auction product category information, current auction product image information, current auction time information, current auction product evaluation price information, current auction product start-price information, and so on) as input data and to use participant bid possibility information of a participant as output data.

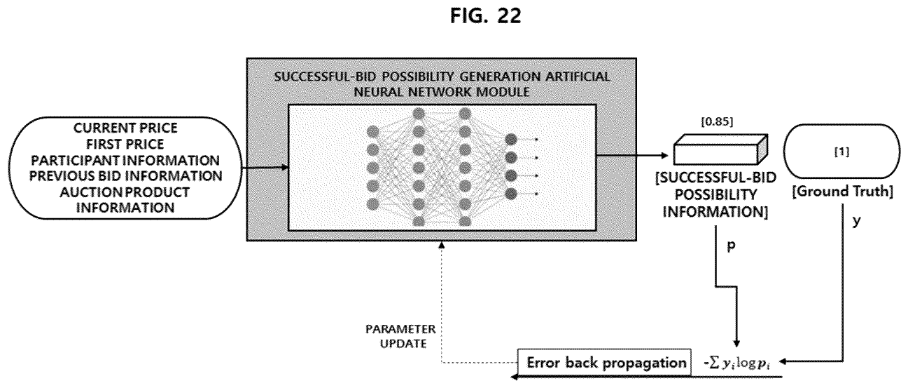

In relation to the successful-bid possibility generation artificial neural network module, FIG. 22 illustrates a schematic view of the successful-bid possibility generation artificial neural network module according to an embodiment of the present disclosure. As illustrated in FIG. 22, the successful-bid possibility information that is input as the reward of the bid price determination reinforcement learning module can be acquired by the successful-bid possibility generation artificial neural network module, and the successful-bid possibility generation artificial neural network module may indicate a previously trained artificial neural network module that uses a current price (a floor or current highest/lowest bid), a first price, participant information, bid information so far, auction product information (category information, image information, and evaluation price information, start-price information, and so on) as input data and uses the successful-bid possibility information as output data. In this case, the successful-bid possibility information means possibility that a corresponding participant bids at a certain price for a corresponding live auction and is successful in the bid.

According to this, when a participant performs a user interface that changes a bid price in real time during a live auction (bid step S12-b, bid step S23-b, and swipe step S32), it is configured to be automatically navigated to a price with a high probability of a successful bid, and thus, it is possible to obtain an effect that bid can be quickly made to the best price to suit the environment for live auction service.

As described above, the present disclosure has the following effects.

First, according to one embodiment of the present disclosure, it is possible to obtain an effect that, even in a live commerce environment in which video is streamed in real time, a live auction can be performed through a plurality of viewer clients.

As described above, those skilled in the art to which the present disclosure belongs will be able to understand that the present disclosure can be embodied in other certain forms without changing a technical idea or essential features of the present disclosure. Therefore, the embodiments described above should be understood as illustrative in all respects and not limiting. The scope of the present disclosure is indicated by the claims to be described below rather than the detailed description, and all changes or modifications derived from the meaning and scope of the claims and equivalent concepts should be construed as being included in the scope of the present disclosure.

The features and advantages described in the present specification do not include all things, and in particular, many additional features and advantages will become apparent to those skilled in the art in consideration of the drawings, specification, and claims. Moreover, it should be noted that the language used herein is chosen primarily for readability and instructional purposes, and may not be chosen to delineate or limit the subject matter of the present disclosure.

The above description of embodiments of the present disclosure is presented for purposes of illustration. It is not intended to limit the present disclosure to the disclosed precise form or to do so without omission. Those skilled in the art can appreciate that many modifications and variations are possible in light of the above disclosure.

Therefore, the scope of the present disclosure is not limited by the detailed description and is limited by any claims in the application based on the detailed description. Accordingly, the disclosure of embodiments of the present disclosure is illustrative and do not limit the scope of the present disclosure set forth in the claims below.

What is claimed is:

1. A user interface implementation method for live auction by an electronic device having a touch-sensitive surface and a display, the user interface implementation method comprising:
a screen display step of displaying a live auction screen on the display;
a touch step of detecting a first input, which is a contact on the touch-sensitive surface, at a first position on the display;
a swipe step of detecting a second input, which is a gesture including a continuous movement of the contact from the first position on the display to a second position without releasing the contact with the touch-sensitive surface; and
a bid step of performing a first function when the contact with the touch-sensitive surface is released at the second position after the second input is detected and performing a second function when the contact with the touch-sensitive surface at the second position is maintained for a certain time or more,
wherein the first function indicates a bid at a first price, and the second function indicates a change from the first price to a second price,
a start portion of a slider, which is a user interface element in a form of the slider in a certain direction, is displayed at the first position on the display in the touch step, and
an end portion of the slider is displayed in the second position in the swipe step.

2. The user interface implementation method of claim 1, wherein the second price indicates a price relatively close to a successful bid rather than the first price.

3. The user interface implementation method of claim 1, wherein, in the bid step, when the first function is performed, a bid message, which is a user interface element in a form of a message for the bid at the first price, is displayed on a certain position of the display.

4. A user interface implementation method for live auction by an electronic device having a touch-sensitive surface and a display, the user interface implementation method comprising:
a screen display step of displaying a live auction screen on the display;
a touch step of detecting a first input, which is a contact on the touch-sensitive surface, at a first position on the display; and
a swipe step of detecting a second input that is a gesture including a continuous movement of the contact in a direction from the first position to a second position on the display or detecting a third input that is a gesture including a continuous movement of the contact in a direction from the first position to a third position on the display, without release of the contact with the touch-sensitive surface after the first input is detected,
wherein a first function is performed when the contact with the touch-sensitive surface is released at the first position after the first input is detected, a second function is performed when the second input is detected, and a third function is performed when the third input is detected,
the first function indicates a bid at a first price, the second function indicates a change from the first price to a second price higher than the first price, and the third function indicates a change from the first price to a third price lower than the first price,
a start portion of a slider, which is a user interface element in a form of the slider in a certain direction, is displayed at the first position on the display in the touch step, and
an end portion of the slider is displayed in the second position in the swipe step.

5. An electronic device comprising:
a touch-sensitive surface and a display;
a processor; and
a memory storing a program configured to be executed by the processor;
wherein the program includes instructions for performing the user interface implementation method for live auction according to claim 1.

6. The electronic device of claim 5, wherein the memory further stores a program code of a bid price determination reinforcement learning module,
the processor processes the program code of the bid price determination reinforcement learning module,
the program code of the bid price determination reinforcement learning module configures an environment as a current price, a first price, participant information, bid information so far, and auction product information, configures a state as the first price, a number of participants, and a bid rate, configures an action as determination of the second price, and configures reward as successful-bid possibility information, and
the participant information indicates a number of participants to which a number of existing bids divided by a number of live auction participations of each participant are applied as weight values.
